(19) United States
(12) Patent Application Publication
(10) Pub. No.: US 2017/0118796 A1
(43) Pub. Date: Apr. 27, 2017

(54) METHOD AND APPARATUS FOR RADIO RESOURCE CONTROL IN A MOBILE NETWORK

(71) Applicant: NOKIA SOLUTIONS AND NETWORKS OY, Espoo (FI)

(72) Inventors: Swaminathan ARUNACHALAM, Plano, TX (US); Ram LAKSHMI NARAYANAN, Pleasanton, CA (US)

(73) Assignee: Nokia Solutions and Networks OY, Espoo (FI)

(21) Appl. No.: 15/307,852

(22) PCT Filed: May 1, 2014
(86) PCT No.: PCT/US2014/036302

§ 371 Date: Oct. 31, 2016

(51) Int. Cl. H04W 76/06; H04L 12/24; H04L 12/851; H04W 76/04

(52) U.S. Cl. CPC H04W 76/068; H04W 76/046; H04L 41/0816; H04L 47/24

(57) ABSTRACT

A method includes, at an applications server, analyzing application flows with respect to at least one device connected to a network; at the application server, generating an adaptive timer value based on application flows of the at least one device; sending the adaptive timer value to at least one server; sending, from the at least one server, the adaptive timer value to the at least one device; and adopting, at the at least one device, the adaptive timer value.

### FIELD OF TECHNOLOGY

This disclosure relates generally to the field of radio resource control in a mobile network.

### BACKGROUND

In mobile networks, user equipment/devices (UE) request radio resources from the Radio Access Network (RAN), and the RAN allocates the required resources to the UE for its use. If there is no activity in either the downlink or the uplink direction, the RAN reclaims the allocated resources from the UE and re-allocates them to other UEs. To attempt to achieve fairness in radio resource allocation, timers are currently used and configured based on traffic, network load, etc.

Radio Resource Control (RRC) is the protocol used to allocate and release resources for each user equipment device connected to a network. RRC has internal states and is maintained both at the UE and the RAN. For example: in 4G and LTE, RRC includes two states, CONNECTED and IDLE; in 3G wireless networks, the states are IDLE, CELL_FACH, CELL DCH, and CELL PCH; and in 4G, the RRC states are connected and disconnected. During RRC, state transitions are based on configured timers and/or the amount of data being exchanged in each state. Generally speaking, these timers are preconfigured by operators for RRC protocol and are fixed.

If these timers are not properly configured, they can poorly affect the Quality of Service (QoS) and Quality of Experience (QoE) of the user traffic. In addition, poorly configured timers can lead to an increased call set-up time due to a lack of radio resource management and can also increase signaling load on the radio network controller.

### SUMMARY

In the present disclosure, a method includes: at an applications server, analyzing application flows with respect to at least one device connected to a network; at the application server, generating an adaptive timer value based on application flows of the at least one device; sending the adaptive timer value to at least one server; sending, from the at least one server, the adaptive timer value to the at least one device; and adopting, at the at least one device, the adaptive timer value.

In another embodiment of the present disclosure, a method includes: on at least one device connected to a network, initiating traffic on the network; receiving the traffic at an application server; performing an application behavior analysis at the application server; at the application server, generating an adaptive timer value based on the application behavior analysis; sending the adaptive timer value to at least one server; sending, from the at least one server, the adaptive timer value to the at least one device; and adopting, at the at least one device, the adaptive timer value.

In yet another embodiment of the present disclosure, an apparatus includes a processor configured to communicate with a network; and a memory in communication with the processor; wherein the processor is further configured to: connect the apparatus to the network; initiate traffic on the network; and adopt an adapted timer value based on the traffic initiated on the network.

### DESCRIPTION OF THE SEVERAL VIEWS OF THE DRAWINGS

To aid in the proper understanding of the present disclosure, reference should be made to the accompanying drawings, wherein:

FIG. 1 is a diagram illustrating an example of state transition of a UE, in accordance with the present disclosure;

FIG. 2 is a flow chart illustrating a method in accordance with an embodiment of the present disclosure;

FIG. 3 is a flow chart illustrating a learning process in accordance with the present disclosure;

FIG. 4 is a flow chart illustrating a method in accordance with an embodiment of the present disclosure;

FIG. 5 is a flow chart in accordance with an embodiment of the present disclosure;

FIG. 6 is a signaling diagram illustrating a method in accordance with the flow chart of FIG. 5;

FIG. 7 illustrates an apparatus in accordance with the present disclosure;

FIG. 8 is a graphical output in accordance with the present disclosure;

FIG. 9 is another graphical output in accordance with the present disclosure; and

FIG. 10 is yet another graphical output in accordance with the present disclosure.

### DETAILED DESCRIPTION

Broadly speaking, the present disclosure provides a method and apparatus for radio resource control (RRC) in a mobile network. As will be described in further detail below, the method includes a learning process and an adaptation flow. During the learning process, an application server learns, for example, user traffic types, application behavior, time of usage, location of usage and other information with respect to each subscriber in the network. After a sufficient set of data is collected by the application server, the application server can predict future behavior of traffic for the same subscribers or for new subscribers, and adapt radio resource control elements based on application behavior of the subscribers. The application server selects appropriate timer and system parameters during this process. Accordingly, based on the present method, network performance and scalability are improved.

As indicated briefly above, RRC is configured to allocate and release resources for each UE in a network. During RRC, the UE will undergo state transitions, which are generally based on configured timers and/or the amount of data being exchanged in each state. Both 3G and 4G protocols have specified states for UEs within the network. Because the present methods and apparatus can be utilized in both 3G and 4G networks, the various states within each protocol will now briefly be described.

In 4G, there are two states: CONNECTED and DISCONNECTED. When the UE is in the CONNECTED state, it is connected to the network; and in the DISCONNECTED state, the UE is idle or not connected to the network. In 4G LTE, the specified states are CONNECTED and IDLE. While in the IDLE state, the UE is turned “on” but is disconnected from the network. In this state, there is no RRC connection between the UE and the network. In accordance with 3G wireless network standards, the UE has four states: IDLE, CELL_FACH, CELL_DCH, and CELL_PCH. In the IDLE state, the UE is turned on, but an RRC connection has not yet been established. In this state, the UE consumes minimal energy. In CELL_DCH (dedicated channel), the UE is in an established state, and a dedicated channel is allocated by the network exclusively to the UE, which can be used for transferring uplink (UL) and downlink (DL) data. In this state, the UE consumes the most power. In CELL_FACH (forward access channel), the UE has established a connection with the network and the network has allocated shared channel resources to the UE. Finally, in CELL_PCH (paging channel), the UE consumes the lowest amount of current, and is unable to send or receive packets.

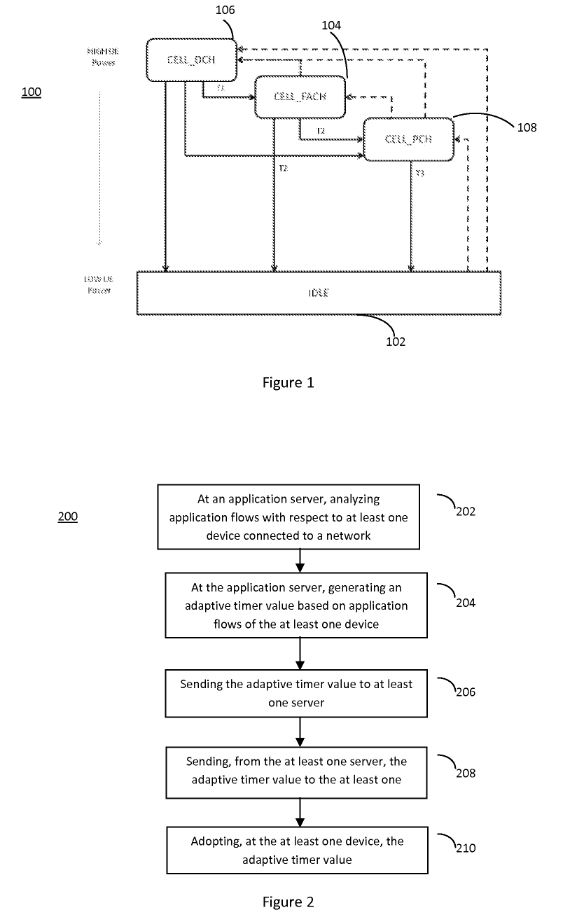

Referring now to FIG. 1, an example of UE state transition in a 3G network is provided. For the UE to remain in the same state, the same data rate is to be maintained. For example, a UE 100 could start in the IDLE 102 state, where it consumes the least amount of power. When the UE 100 establishes a connection to the RAN, the UE can first move to CELL_FACH 104, where a relatively low volume of data can be transmitted. When the UE 100 moves to a new application requiring a higher volume of data transmission, it moves to CELL_DCH 106, where a dedicated channel is allocated exclusively to the UE. While the UE 100 is in CELL_DCH 106, the highest amount of power is utilized. After a specified period of inactivity is met (based on a pre-configured inactivity timer, for example) and no data is exchanged, the UE 100 can then transition states again to either CELL_FACH 104 or CELL_PCH 108, for example.

Utilizing a fixed or pre-configured timer in state transitions can be ineffective and reduce UE energy. Specifically, in some current RRC methods, there is a lack of guidance regarding applications' traffic type and duration, which can render the fixed timer configuration ineffective. For example, some operators have one set of configurations that is used during off-peak and on-peak hours, and that are homogeneously applied network-wide. While such a configuration may provide temporary relief in a crowded network, the fixed timers can lead to poor or inefficient RRC protocol because the same timer is utilized throughout the network, regardless of the load on the network or the traffic utilized by the application, for example.

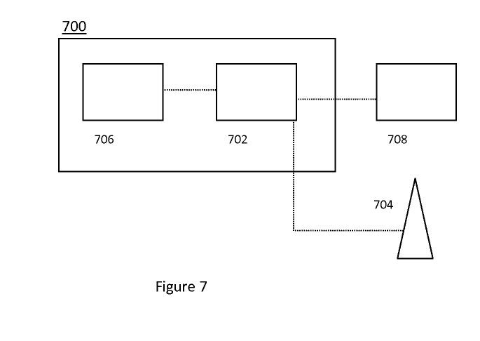

The present disclosure addresses the above issues by implementing an active learning technique using an application server and enabling real-time adaptive timer management. Specifically, the present disclosure includes a method 200 in accordance with FIG. 2. At 202, application flows are analyzed at an application server (shown in FIG. 7 and described in greater detail below) with respect to at least one device connected to a network. At 204, an adaptive timer value is generated at the application server based on the application flows of the at least one device. At 206, the adaptive timer value is sent to at least one server, which then sends the adaptive timer value to the at least one device (208). At 210, the at least one device adopts the adaptive timer value.

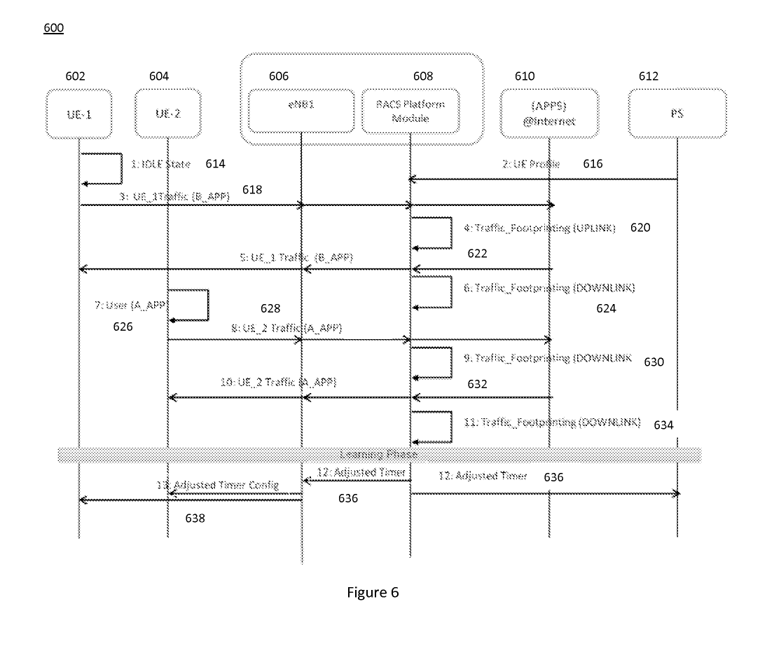

In the present disclosure, the application server is an IT server module known as a Radio Applications Cloud Server (RACS) 608 (described in further detail below with reference to FIG. 6). The RACS is integrated into the RAN; for example, it can be integrated into the Radio Network Controller (RNC) in a 3G network or into the eNodeB (eNB) in an LTE network. The RACS enables, among other things, deployment and hosting of local applications at the RAN side in a virtualization computing environment and applying cloud technologies.

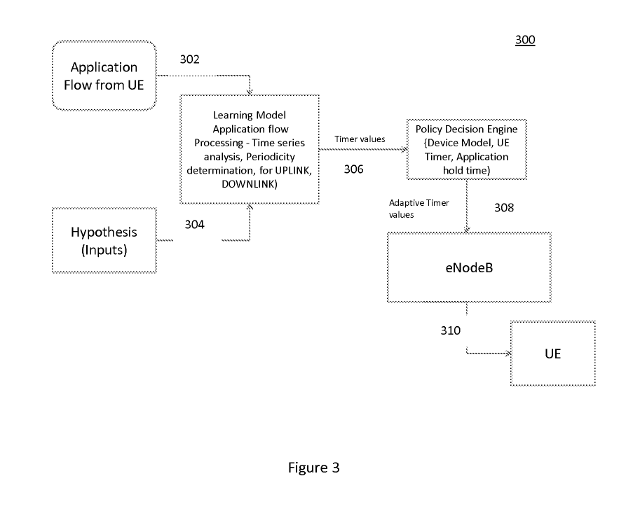

In the method 200, the RACS analyzes the application flows with respect to the at least one device by utilizing a learning method 300, which is illustrated in FIG. 3. During the learning method, application behavior is analyzed, in that the RACS processes application flows and learns the IP flows that pass there through. The RACS also learns the application flows and the arrival rate of traffic with respect to each of the devices connected to the network. Broadly speaking, the analyzing or learning method includes, among other things, extracting information or input data from the at least one device. The extracted information can include, for example, IP flow information, associate request and response timing, subscriber information, device model information, and location information. In addition, during the learning method, the RACS analyzes, for example, packet processing, packet classification, request size, response size, flow identification, signature identification, and state transition detection. As will be described in further detail below, as a result of the learning method 300, a learning model can be created to assist the RACS in identifying the adaptive timer value.

Referring specifically to FIG. 3, in the learning method 300, user plane traffic or application flows that flow through the RACS are taken as input data (302). Specifically, the RACS extracts the input data from the device(s) connected to the network. As indicated above, the extracted input data can be common protocol properties such as, for example, IP flow information, associate request and response timing, subscriber information, subscription information, service information, device model information, and other supplementary information as needed. At 304, the RACS can communicate with a hypothesis history database (HHD). The HHD can store extracted device information from previous applications of the learning method 300. The RACS can compare its values with those stored in the HHD and use the additional inputs in the HHD to improve the performance of the learning method 300 in both efficiency and accuracy, as will be described in further detail below. At 306, the learning method 300 continues by analyzing additional data at the RACS, such as packet processing, packet classification based on key protocol extraction fields, the size of each request/response from/to each device on the network, flow identification, signature identification, state transition detection, burstiness detection, and time-of-day correlation, for example. However, the analyzing at 306 is not limited to these factors. The learning method 300 repeats steps 302-306 until an adaptive timer value can be determined to best suit the device. At 308, the final output or adaptive timer value is communicated to the eNB or base transceiver station (BTS) for reconfiguring the network. Finally, at 310, the adaptive timer value is communicated to the device, which then adopts the adaptive timer value.

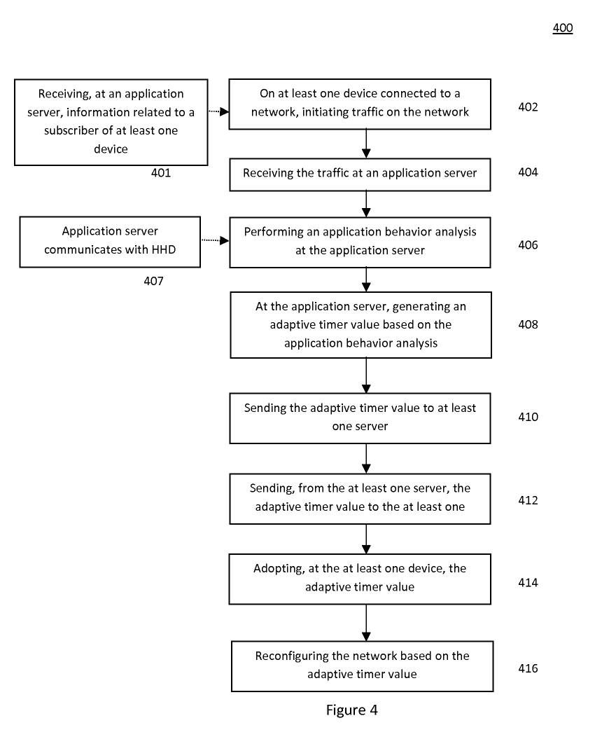

The learning method 300 is also implemented within additional embodiments of the present disclosure. For example and turning now to FIG. 4, a method 400 in accordance with the present disclosure is provided. In the method 400, at least one device is connected to a network, and at 402, initiates traffic on the network. For example, initiating traffic on the network can include initiating a web page request and/or using an application on the device, although it is to be understood that other forms of traffic can be initiated on the network, as known in the art. At 404, the traffic is received at the application server or RACS. For example, the RACS may receive one of uplink traffic and downlink traffic from the device. At 406, the RACS performs an application behavior analysis in accordance with the learning method 300 (see FIG. 3). For example and as described above with reference to FIG. 3, the RACS may analyze packet processing, packet classification, request size, response size, flow identification, signature identification, and state transition detection, among other things. Based on the application behavior analysis, the application server generates an adaptive timer value at 408. At 410, the adaptive timer value is sent to at least one server, such as a Policy Server or an eNB. The server then sends the adaptive timer value to the at least one device at 412, and at 414, the at least one device adopts the adaptive timer value. At 416, the network can be reconfigured based on the adaptive timer value.

The method 400 can also optionally include receiving, at the RACS, information related to a subscriber of the at least one device (401). For example, when the device connects to the network, a Policy Server (not shown) or other entities (i.e., MME or PCRF, also not shown) can push subscriber-related information to the RACS, such as device profile and subscriber traffic flow template profile. Further, the method 400 can also optionally include, at 407, having the RACS communicate with the hypothesis history database (HHD). As stated briefly above with respect to FIG. 3, the HHD stores extracted device information from previous applications of the application behavior analysis or learning method 300. The RACS can compare its values with those stored in the HHD and use the additional inputs in the HHD to improve the performance of the method 400 in both efficiency and accuracy. For example, if any of the device profile and application information pushed to the RACS at 401 matches data/information previously analyzed during the learning method 300 (step 406 in the method 400), the matching data can be used to group user behavior and provide common configurations for assisting in developing an accurate adaptive timer value.

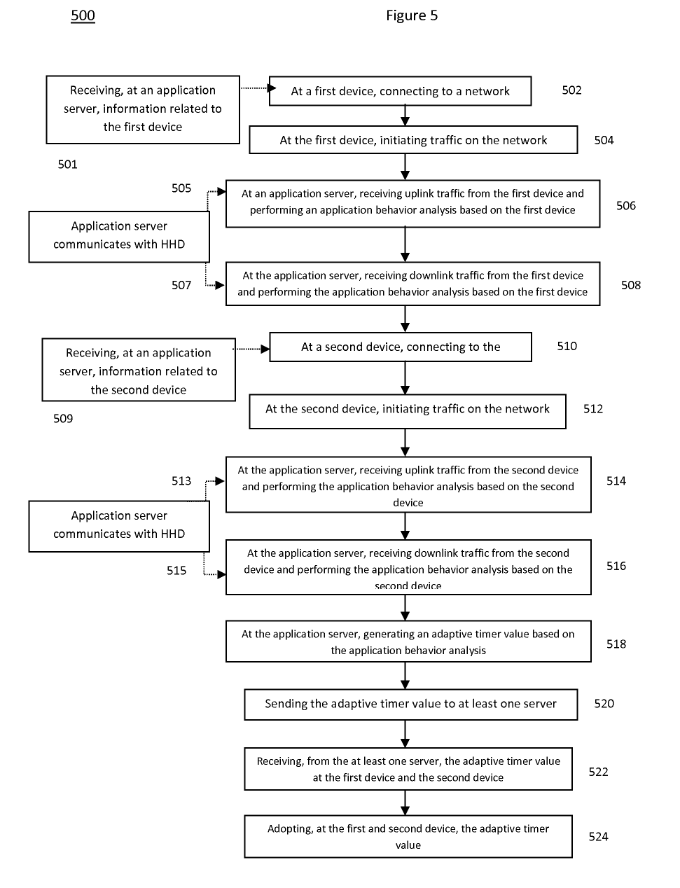

Referring next to FIG. 5, another embodiment of the present disclosure is provided. Specifically, in method 500, a scenario is provided in which a first user device (UE1) and a second user device (UE2) are connected to the network. At 502, UE1 connects to the network and initiates traffic on the network (504), such as initiating a web page request or performing a function on a device application. At 506, the application server or RACS receives uplink traffic from UE1 and performs an application behavior analysis or learning method (in accordance with learning method 300 described in detail above with respect to FIG. 3). The RACS then receives downlink traffic from the first device and performs application behavior analysis based on the learning method 300 (508). The RACS then combines the data from the application behavior analyses performed at 506 and 508 (not shown). At 510, UE2 connects to the network and initiates traffic on the network (512). The RACS receives uplink traffic from UE2 and performs application behavior analysis based on UE2 and in accordance with the learning method 300 described above in detail (514). At 516, the RACS receives downlink traffic from UE2 and performs application behavior analysis based on the second device and in accordance with the learning method 300. The RACS combines the data from the application behavior analyses performed at 514 and 516. Based on the results of the application behavior analyses, the RACS generates an adaptive timer value (518) and send the adaptive timer value to at least one server (520), such as a Policy Server or eNB. At 522, the server sends the adaptive timer value to both UE1 and UE2, and UE1 and UE2 both adopt the adaptive timer value (524).

The method 500 can also include receiving, at the RACS, information related to a subscriber of UE1 (501) and UE2 (509). For example, when UE1 and UE2 connect to the network, a Policy Server (not shown) or other entities (i.e., MME or PCRF, also not shown) can push subscriber-related information to the RACS, such as device profile and subscriber traffic flow template profile. Further, the method 500 can also include having the RACS communicate with the hypothesis history database (HHD) (see steps 505, 507, 513, 515, respectively). As stated briefly above with respect to FIG. 3, the HHD stores extracted device information from previous applications of the application behavior analysis or learning method 300. The RACS can compare its values with those stored in the HHD and use the additional inputs in the HHD to improve the performance of the method 500 in both efficiency and accuracy. For example, if any of the device profile and application information matches data/information previously analyzed and stored in the HHD, the matching data can be used to group user behavior and provide common configurations for assisting in developing an accurate adaptive timer value.

FIG. 6 illustrates a signaling diagram 600 in accordance with the method 500 described in reference to FIG. 5. In the signaling diagram 600, the following components can be involved and in communication with each other, either directly or indirectly: UE1 602, UE2 604, an eNB 606, an application server or RACS 608, Internet 610, and Policy Server (PS) 612. At 614, UE1 is turned ON, has performed a Location Update operation, and is considered to be in an IDLE state. In this scenario and in accordance with the present disclosure, IDLE is with respect to an application; in other words, there is currently no user activity and the user has either activated or not activated many background services available on the UE1. For example, if a user has subscribed to Facebook® synchronization or push services, the application could generate periodic activity towards the Internet, such as status update notifications, messages, news feed updates, etc. However, because the user is not actively using the device, UE1 is still considered to be in an IDLE state. After UE1 latches onto the network, at 616 the PS 612 (or other entities, such as an MME or PCRF, not shown) pushes subscriber-related information and UE1 profile information to the RACS 608. At 618, UE1 initiates traffic in an application and sends a request to the Internet 610. At 620, upon receipt of the uplink traffic from UE1, the RACS 608 performs the application behavior analysis (in accordance with method 500 described above). At 622, the Internet responds to the request from UE1 602. Upon receipt of the downlink traffic from the Internet 610, at 624 the RACS 608 performs application behavior analysis (in accordance with method 500 described above).

At 626, a user of UE2 operates an application, which may or may not be the same application used by UE1 above. It is to be noted that UE2 could be a different model, manufacturer, application version, or OS from UE1, for example. At 628, UE2 initiates traffic in the application and sends a request to the Internet 610. At 630, upon receipt of the uplink traffic from UE2, the RACS 608 performs the application behavior analysis (in accordance with method 500 described above). At 632, the Internet responds to the request from UE2. Upon receipt of the downlink traffic from the Internet 610, at 634 the RACS performs application behavior analysis (in accordance with method 500 described above). At 636, and after the completion of the application behavior analyses, the RACS 608 generates an adapted timer value and sends it to both the Policy Server 612 and the eNB 606. At 638, the adapted timer value is sent to both UE1 and UE2, which then adopt the value.

The user device or UE 700 is illustrated in the block diagram of FIG. 7. As shown in FIG. 7, the UE 700 includes a processor 702 configured to communicate with a network 704, and a memory 706 in communication with the processor. The processor 702 is configured to, in accordance with the methods 200, 300, 400 and 500 described above, connect the UE 700 to the network 704, initiate traffic on the network, and adopt an adapted timer value based on the traffic initiated on the network. The UE 700 is in communication with an application server or RACS 708, and as described in detail above with reference to methods 200, 300, 400 and 500, the application server is configured to, among other things, receive a request from the UE, perform an application behavior analysis based on the request, determine an adapted timer value based on the application behavior analysis, and send the adapted timer value to the UE. Although other devices may be appropriate, the UE 700 is a communication device such as a portable communication device, mobile communication device, smartphone, tablet, laptop, or personal computer.

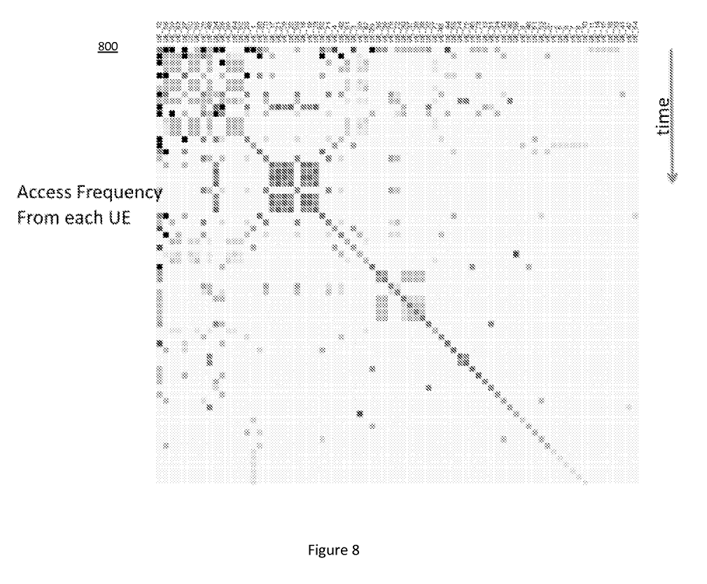

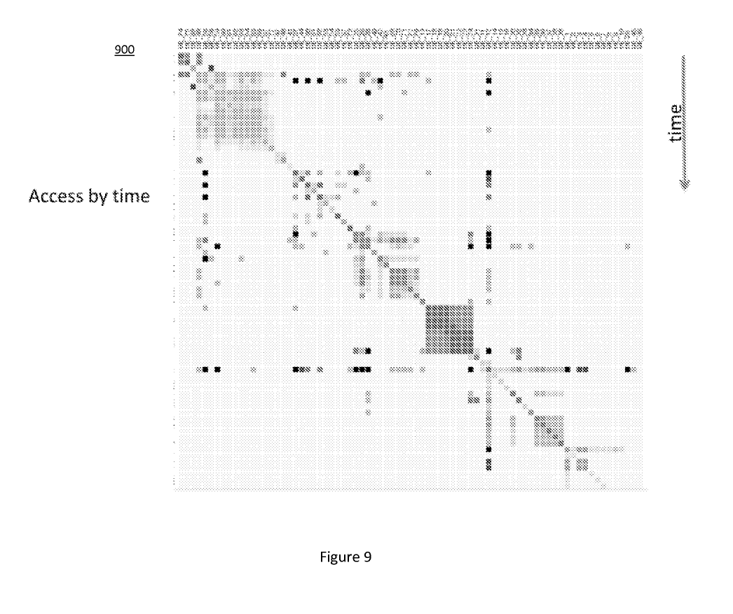

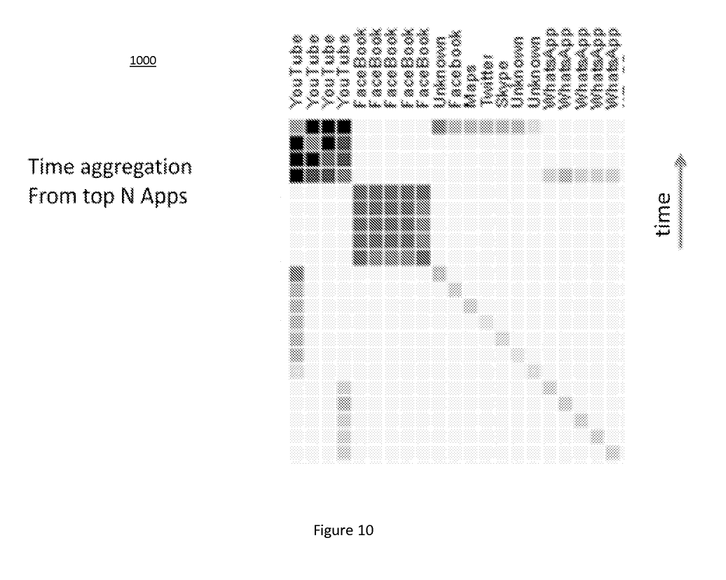

FIGS. 8-10 show the application-usage behavior of several user equipment devices UEx attached to the RAN over a period of time. Specifically, in FIG. 8, UE1-UE75 are shown and their behavior and frequency of access tracked over a period of time and utilizing a fixed timer value. As can be seen by the outputs on graph 800, it is difficult to derive any knowledge from the outputs in graph 800 because there is no synchronization between the user accessing the system, the device generating a signaling load, and application-generating traffic. Turning next to FIG. 9, UE1-75 are again tracked and grouped together based on similar network characteristics. The UEs are tracked based on their user access throughout the day and the frequency of their access. In graph 900 shown in FIG. 9, due to the learning process described in the present disclosure, UEs are grouped together based on access patterns and OS types of the UEs, thus rendering it possible to determine adaptive timer values that can reduce signaling load on the network. Taking the analysis one step further, FIG. 10 shows graph 1000, in which usage/frequency of various application types is tracked based on user access throughout the day and the frequency of such access. As seen in graph 1000, clusters of usage are clearly formed, with different colors within the clusters indicating different data/subscription plans, for example. This information, which is part of the learning process described in detail above, can be used to develop adaptive timer values that can increase the scalability of the network, for example.

The present disclosure provides an apparatus and methods for implementation of an adaptive timer value for use in Radio Resource Control. Such an adaptive timer is becoming more important because of the nature of the Internet and the applications running on user devices. For example, with the onset of more video content and chat features in Internet applications, traditional web page requests are becoming less prevalent. Accordingly, traditional fixed timer mechanisms for RRC are becoming less efficient because the various types of applications (i.e., video, IM, chat, traditional web traffic, VoIP, gaming) each have different requirements on the network. Furthermore, because user devices have different OS, models, and application versions, fixed timer configurations are unable to efficiently handle various RRC requests.

The present methods and apparatus provide a machine learning approach (using the RACS or application server) to learn and analyze various inputs including application flows, device characteristics, and network load characteristics, for example, to dynamically configure adaptive timer values. The methods disclosed herein result in conserved UE energy, improved BTS scheduling, and reduced radio signaling, among other features. In addition, the present apparatus and methods can enhance UE energy for future flows by utilizing information from each UE and by consulting an HHD that stores previously analyzed application behaviors. Further, because the adaptive timer values are UE-specific and not network specific, UE efficiency is increased and UE energy is conserved. Utilization of the present apparatus and methods can also improve radio scheduling because of the use of the adaptive timer values. Also, radio signaling messages can be reduced by implementing the present apparatus and methods, because the application server is doing the majority of the work by performing the application behavior analyses or learning method and by consulting the HHD for previously stored device/profile information.

Embodiments of the present disclosure may be implemented in software (executed by one or more processors), hardware (e.g., an application specific integrated circuit), or a combination of software and hardware. In an example embodiment, the software (e.g., application logic, an instruction set) is maintained on any one of various conventional non-transitory computer-readable media. In the context of this document, a “non-transitory computer-readable medium” may be any media or means that can contain, store, communicate, propagate or transport the instructions for use by or in connection with an instruction execution system, apparatus, or device, such as a computer. A non-transitory computer-readable medium may comprise a computer-readable storage medium (e.g., memory or other device) that may be any media or means that can contain or store the instructions for use by or in connection with an instruction execution system, apparatus, or device, such as a computer. As such, the present invention includes a computer program product comprising a computer-readable storage medium bearing computer program code embodied therein for use with a computer, the computer program code comprising code for performing any of the methods and variations thereof as previously described. Further, the present invention also includes an apparatus which comprises one or more processors, and one or more memories including computer program code, wherein the one or more memories and the computer program code are configured, with the one or more processors, to cause the apparatus to perform any of the methods and variations thereof as previously described.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

The following abbreviations that may be found in the specification and/or the drawing figures are defined as follows:

BTS Base Transceiver Station

CELL DCH Dedicated Channel

CELL FACH Forward Access Channel

CELL_PCH Paging Channel

eNB eNodeB

HHD Hypothesis History Database

LTE Long Term Evolution

MME Mobility Management Entity

PCRF Policy Charging & Rules Function

PS Policy Server

QoE Quality of Experience

QoS Quality of Service

RACS Radio Applications Cloud Server

RAN Radio Access Network

RRC Radio Resource Control

UE User Equipment/Device

1. A method comprising:
at an application server, analyzing application flows with respect to at least one device connected to a network;
at the application server, generating an adaptive timer value based on application flows of the at least one device;
sending the adaptive timer value to at least one server;
sending, from the at least one server, the adaptive timer value to the at least one device; and
adopting, at the at least one device, the adaptive timer value.

2. The method of claim 1 wherein analyzing application flows with respect to at least one device connected to a network comprises extracting information from the at least one device.

3. The method of claim 2 wherein extracting information from the at least one device includes extracting at least one of IP flow information, associate request and response timing, subscriber information, device model information, and location information.

4. The method of claim 1 wherein generating an adaptive timer value based on application flows of the at least one device comprises analyzing, at the application server, at least one of packet processing, packet classification, request size, response size, flow identification, signature identification, and state transition detection.

5. The method of claim 1 further including, at the application server, communicating with a database to determine whether the application flows match previously determined application flows.

6. The method of claim 1 further comprising the step of reconfiguring the network based on the adaptive timer value.

7. A method comprising:
on at least one device connected to a network, initiating traffic on the network;
receiving the traffic at an application server;
performing an application behavior analysis at the application server;
at the application server, generating an adaptive timer value based on the application behavior analysis;
sending the adaptive timer value to at least one server;
sending, from the at least one server, the adaptive timer value to the at least one device; and
adopting, at the at least one device, the adaptive timer value.

8. The method of claim 7 wherein initiating traffic on the network includes at least one of initiating a web page request and using an application on the at least one device.

9. The method of claim 7 further including the step of receiving, at the application server, information related to a subscriber of the at least one device.

10. The method of claim 9 wherein the information related to a subscriber of the at least one device includes at least one of device profile and subscriber traffic flow template profile.

11. The method of claim 7 wherein receiving the traffic at an application server includes at least one of receiving uplink traffic from the at least one user device and receiving downlink traffic from the at least one user device.

12. The method of claim 7 wherein performing an application behavior analysis at the application server comprises analyzing, at the application server, at least one of packet processing, packet classification, request size, response size, flow identification, signature identification, and state transition detection.

13. The method of claim 7 further including, at the application server, communicating with a database to determine whether the application flows match previously determined application flows.

14. The method of claim 7 further comprising the step of reconfiguring the network based on the adaptive timer value.

15. An apparatus comprising:
a processor configured to communicate with a network; and
a memory in communication with the processor;
wherein the processor is further configured to:
connect the apparatus to the network;
initiate traffic on the network; and
adopt an adapted timer value based on the traffic initiated on the network.

16. The apparatus of claim 15 wherein the apparatus is in communication with an application server, and the application server is configured to:
receive a request from the apparatus;
perform an application behavior analysis based on the request from the apparatus;
determine an adapted timer value based on the application behavior analysis; and
send the adapted timer value to the apparatus.

17. The apparatus of claim 15 wherein the apparatus is a portable communication device.

18. The apparatus of claim 16 wherein the apparatus is configured to adopt the adapted timer value.

19. The apparatus of claim 15 wherein the traffic initiated on the network includes one of initiating a web page request and using an application on the at least one device.

20. A method comprising:
at a first device, connecting to a network;
at the first device, initiating traffic on the network;
at an application server, receiving uplink traffic from the first device and performing an application behavior analysis based on the first device;
at the application server, receiving downlink traffic from the first device and performing the application behavior analysis based on the first device;
at a second device, connecting to the network;
at the second device, initiating traffic on the network;
at the application server, receiving uplink traffic from the second device and performing the application behavior analysis based on the second device;
at the application server, receiving downlink traffic from the second device and performing the application behavior analysis based on the second device;
at the application server, generating an adaptive timer value based on the application behavior analysis;
sending the adaptive timer value to at least one server;
receiving, from the at least one server, the adaptive timer value at the first device and the second device; and
adopting, at the first device and the second device, the adaptive timer value.
